(19) United States
(12) Patent Application Publication
(10) Pub. No.: US 2024/0282499 A1
(43) Pub. Date: Aug. 22, 2024

(54) TRANSFORMER FOR DATA CENTER

(71) Applicant: Hebei Starge Data Technology Investment Co., Ltd., Zhangjiakou City (CN)

(72) Inventors: Binghua ZHANG, Zhangjiakou City (CN); Mingjiang LI, Zhangjiakou City (CN)

(21) Appl. No.: 18/581,465

(22) Filed: Feb. 20, 2024

(30) Foreign Application Priority Data
Feb. 22, 2023 (CN) 202310148099.9

(51) Int. Cl. H01F 27/00; H02M 7/00

(52) U.S. Cl. CPC H01F 27/006; H02M 7/003

(57) ABSTRACT

Embodiments of the present disclosure provide a transformer for a data center. The transformer is a split winding transformer or a double winding transformer with a voltage level of 220 kV. The transformer includes two 10 kV low-voltage windings, each of the two 10 kV low-voltage windings is connected to two sections of 10 kV busbars, a plurality of outgoing lines are connected to each of the two sections of 10 kV busbars, and the outgoing lines are configured to connect a power distribution device of the data center.

### CROSS REFERENCE TO RELATED APPLICATION

This application claims priority to Chinese Patent Application No. 202310148099.9, titled “TRANSFORMER FOR DATA CENTER” and filed to the China National Intellectual Property Administration on Feb. 22, 2023, the entire contents of which are incorporated herein by reference.

### TECHNICAL FIELD

The present disclosure relates to the field of data center technology, and more particularly, to a transformer for a data center.

### BACKGROUND

With the rapid development of the Internet, more and more industries are relying on the Internet to provide services to users. For example, online education, online consultation and remote work, which are respectively involved in education, healthcare, and work, need to rely on the Internet for implementation. These industries are exploding rapidly, and their demands for bandwidth and storage resources of the Internet are becoming increasingly prominent. To meet the growing demands for the resources, development scale of data center infrastructure will also expand accordingly.

At present, power capacity of some large data centers is 200 to 300 MW generally, far exceeding power supply capacity of a 110 KV substation. To solve the power supply bottleneck, the power supply capacity of the substation can be improved by increasing a voltage level of the substation or increasing capacity of the single substation. Considering that high-voltage users generally have lower wheeling charges than medium-voltage users, substations with higher voltage levels can save significant electricity fees for the electricity users throughout the entire life cycle. Therefore, building a 220 kV high-voltage substation is a better solution to the above-mentioned power supply problems.

By studying existing data center power supply technologies, inventors of the present disclosure have found that in general, the 220 kV substation includes three voltage levels: 220/110/10 kV, and its construction costs are higher. Moreover, in most cases the capacity of the 220 kV transformer is 150/180/240 MVA, and maximum rated current of a conventional 10 kV incoming cubicle of a main transformer is 4,000 A. Therefore, maximum current carrying capacity of the 10 kV switch cubicle will be exceeded when a conventional double-winding transformer is used. Furthermore, because short-circuit capacity on a 220 kV side is larger, excessive short-circuit current will be generated on a 10 kV side when a transformer with conventional impedance is used, which may damage devices in severe cases.

### SUMMARY

To solve some or all of the problems in the existing technologies, an embodiment of the present disclosure provides a transformer for a data center. The technical solutions are described as follows.

The transformer is a split winding transformer or a double winding transformer with a voltage level of 220 kV. The transformer includes two 10 kV low-voltage windings, each of the two 10 kV low-voltage windings is connected to two sections of 10 kV busbars, and a plurality of outgoing lines are connected to each of the two sections of 10 kV busbars, where the outgoing lines are configured to connect a power distribution device of the data center.

Further, any two sections of the 10 kV busbars are not coupled to each other.

Further, the split winding transformer is used when capacity of the transformer is greater than 120 MVA; and the double winding transformer is used when the capacity of the transformer is less than or equal to 120 MVA.

By adopting the above embodiment, the present disclosure at least can produce following technical effects.

Generally, the voltage level of the power distribution device of the data center is 10 kV. When a 220 kV substation is employed to supply power, total electrical energy may be transformed from 220 kV to 10 kV to connect the power distribution device. In this way, the voltage level of 110 kV is left out, and construction costs of the substation are reduced. First, compared to a 110 KV substation, adopting the 220 kV substation not only improves power supply capacity of a single substation, but also saves grid-side and municipal resources. Second, the voltage level of the power distribution device in the data center is typically 10 kV. The 220 kV substation provided in the present disclosure may transform the total electrical energy from 220 kV to 10 kV to connect the power distribution device, which leaves out the voltage level of 110 kV and thus reduces the construction costs of the substation. Third, high-voltage users generally have lower wheeling charges than medium-voltage users, and adopting 220 kV power supply can significantly save electricity fees throughout the entire life cycle compared to medium voltage power supply. Fourth, by adjusting a form of a main transformer and optimizing the form of a main wiring without changing a 10 kV side standard device, a 10 kV bus tie cabinet may be canceled, which can fully utilize total capacity of the main transformer and ensure reliable power supply to the data center.

### BRIEF DESCRIPTION OF THE DRAWINGS

To describe the technical solutions in the embodiments of the present disclosure more clearly, the accompanying drawings required for describing the embodiments will be briefly introduced below. Apparently, the accompanying drawings in the following description are merely some embodiments of the present disclosure. To those of ordinary skills in the art, other accompanying drawings may also be derived from these accompanying drawings without creative efforts.

FIG. 1 is a schematic diagram of main wiring of a transformer for a data center according to an embodiment of the present disclosure; and

FIG. 2 is a schematic diagram of the main wiring of a substation using the transformer shown in FIG. 1 according to an embodiment of the present disclosure.

### DETAILED DESCRIPTION

To make the objectives, technical solutions and advantages of the present disclosure clearer, the embodiments of the present disclosure are further described as below in details with reference to the accompanying drawings. The terms such as “upper”, “above”, “lower”, “below”, “first end”, “second end”, “one end”, “other end” as used herein, which denote spatial relative positions, describe the relationship of one unit or feature relative to another unit or feature in the accompanying drawings for the purpose of illustration. The terms of the spatial relative positions may be intended to include different orientations of a device in use or operation other than the orientations shown in the accompanying drawings. For example, a unit that is described as “below” or “under” other units or features will be “above” the other units or features when the device in the accompanying drawings is turned upside down. Thus, the exemplary term “below” may encompass both the orientations of above and below. The device may be otherwise oriented (rotated by 90 degrees or facing other directions) and the space-related descriptors used herein are interpreted accordingly.

In addition, terms “installed”, “arranged”, “provided”, “connection”, “sliding connection”, “fixed”, and “sleeved” should be understood in a broad sense. For example, the “connection” may be a fixed connection, a detachable connection or integrated connection, a mechanical connection or an electrical connection, a direct connection or indirect connection by means of an intermediary, or internal connection between two apparatuses, elements, or components. The specific significations of the above terms in the present disclosure may be understood in the light of specific conditions by persons of ordinary skill in the art.

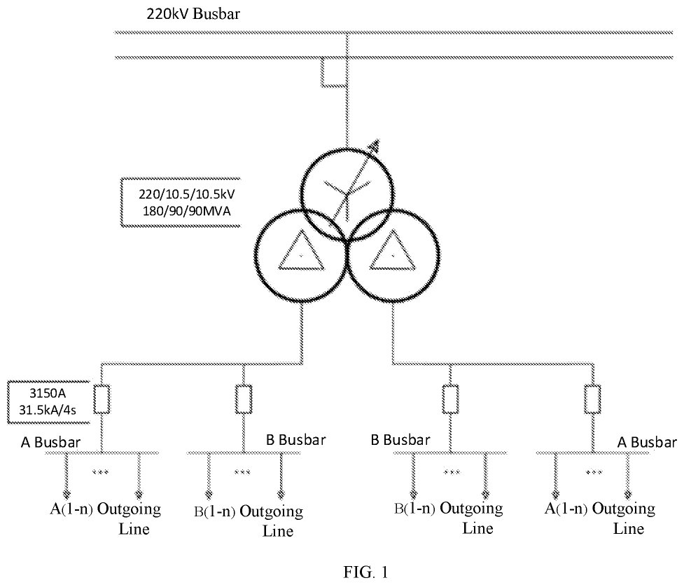

With reference to FIG. 1, the embodiments of the present disclosure provide a transformer for a data center. The transformer is a split winding transformer or a double winding transformer with a voltage level of 220 kV. The transformer includes two 10 kV low-voltage windings, each of the two 10 kV low-voltage windings is connected to two sections of 10 kV busbars, a plurality of outgoing lines are connected to each of the two sections of 10 kV busbars, and the outgoing lines are configured to connect a power distribution device of the data center.

In implementation, a high-voltage winding of the transformer is relative to the low-voltage winding. When an input voltage is 220 kV and an output voltage is 10 kV, an input end is the high-voltage winding and an output end is the low-voltage winding.

In one embodiment, any two sections of the 10 kV busbars are not coupled to each other.

In implementation, a 10 kV bus tie cabinet may be canceled to save construction costs.

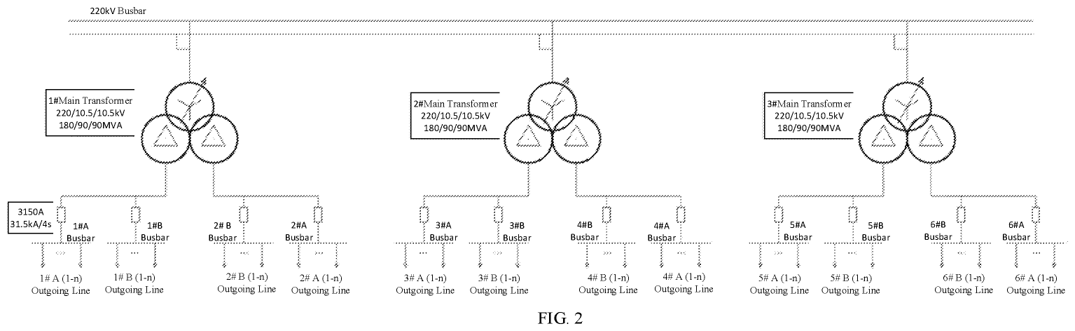

In implementation, a plurality of transformers mentioned above may be connected in parallel by means of double-bus configuration to serve as main transformers for substations used in the data center. With reference to FIG. 2, 220 kV windings of each of the main transformers use the double-bus configuration, 10 kV windings of each of the main transformers are connected to two sections of 10 kV busbars, and one or more outgoing lines are connected to each section of the 10 kV busbars.

In implementation, when capacity of the transformer is greater than 120 MVA (megavolt ampere), the split winding transformer may be used, such as the split winding transformer with the voltage level of 220/10.5/10.5 kV and the capacity of 180/90/90 MVA. When the capacity of the main transformer is less than or equal to 120 MVA, a conventional double winding transformer may be used, such as the conventional double winding transformer with the voltage level of 220/10.5 kV and the capacity of 120/120 MVA.

In general, a 220 kV transformer includes three voltage levels: 220/110/10 kV. In the present disclosure, 220 kV is directly transformed to 10 kV to supply power, eliminating the voltage level of 110 kV and thus reducing construction costs of the transformer.

It is worth mentioning that to prevent voltage drop, an actual voltage may increase or decrease according to a distance between lines. An allowable voltage deviation of electrical equipment is generally ±5%, while the voltage drop along the lines is generally 10%. Thus, the actual voltage at a beginning end of the line may be adjusted to 105% of a rated voltage, such that a terminal voltage thereof is not less than 95% of the rated voltage. Therefore, to obtain a 10 kV power supply voltage, the voltage of the main transformer may be directly reduced from 220 kV to 10.5 kV.

In one embodiment, each of the main transformers is the split winding transformer, and a half-ride-through impedance of the split winding transformer is 45%. Of course, in another embodiment, a short-circuit impedance is adjusted according to actual situations.

In one embodiment, a first 10 kV busbar of a first main transformer and a second 10 kV busbar of a second main transformer serve as backup for each other.

In implementation, according to power supply requirements of the data center, power supply to one computer room needs to ensure that two sections of 10 kV busbars from different transformers have 10 kV outgoing lines. During normal operation, each of the two sections of 10 kV busbars carries 50% of load. In the case of N−1, one of the two sections of 10 kV busbars is out of power, and the other one of the two sections of 10 kV busbars carries the entire load. That is, when any one of the 10 kV busbars experiences a power outage, the load of this 10 kV busbar that experiences the power outage will continue to be powered by the corresponding backup 10 kV busbar.

It is worth mentioning that N−1 refers to ability of a power system to maintain stable operation and normal power supply when any one element in the power system is switched off without any fault or switched off due to a fault while other elements are not overloaded and can maintain stable and continuous power supply of the system in a normal operation mode.

In one embodiment, any two sections of the 10 kV busbars are not coupled to each other.

In implementation, because backups have been made on the main transformer and a 10 kV device, there is no need to further couple the 10 kV busbars. Therefore, the present disclosure can cancel the tie cabinet to save the construction costs.

In one embodiment, the capacity of each main transformer is 100/120/150/180/240 MVA.

In implementation, the capacity of the main transformer may be selected according to actual power demands of the data center. The capacity of any main transformer may be 100 MVA, 120 MVA, 150 MVA, 180 MVA, or 240 MVA.

In one embodiment, the substation used in the data center may include two to four main transformers.

In implementation, number of the main transformers may be set according to the actual power demands, and the present disclosure does not impose any restrictions on this. In a preferred embodiment, two to four main transformers may be arranged out of comprehensive considerations of factors such as power demands and construction costs of the data center.

In one embodiment, the power supply system also includes an incoming cubicle corresponding to each section of the 10 kV busbars.

In implementation, a 10 kV switch cubicle with different parameters may be selected according to the actual power demands of the data center, but the present disclosure is not limited thereto. For example, rated current of the incoming cubicle of the main transformer may be 3,150/4,000 A. Rated short-time withstand current may be 25/31.5/40 kA, and duration may be 4 s.

The incoming cubicle may include vacuum circuit breakers, isolation switches, three sets of three-winding current transformers, lightning arresters, live displays, voltage transformers, wires, and so on, but the present disclosure is not limited thereto.

In FIG. 2, the substation may include three split winding transformers with the voltage level of 220/10.5/10.5 kV, the capacity of 180 MVA, and the half-ride-through short-circuit impedance of 45%. The three split winding transformers are referred to as 1 #main transformer, 2 #main transformer, and 3 #main transformer, respectively. A 220 kV side of each of the main transformers adopts the double-bus configuration, which may also be adjusted according to actual importance level and scale of the substation. A 10 kV side of each of the main transformers adopts a double-branch wiring mode. That is, the 10 kV winding of each main transformer is connected to two sections of 10 kV busbars, denoted as section A and section B, respectively. The section A and the section B of different main transformers serve as backup for each other, which can meet power supply reliability requirements of the data center.

Rated current of inline space of the main transformer is 3,150 A, and the short-time withstand current is 31.5 kA/4 s. Of course, the rated current of the inline space of the main transformer may be adjusted according to actual needs. For example, when the capacity of the main transformer is 240/120/120 MVA, the rated current is 4,000 A. The short-time withstand current may also be adjusted according to the actual situations.

The 10 kV busbar in this embodiment has a total of 12 sections. The 10 kV busbars of the 1 #main transformer are referred to as 1 #A busbar, 1 #B busbar, 2 #A busbar, and 2 #B busbar, respectively. The 10 kV busbars of the 2 #main transformer are referred to as 3 #A busbar, 3 #B busbar, 4 #A busbar, and 4 #B busbar, respectively. The 10 kV busbars of the 3 #main transformer are respectively referred to as 5 #A busbar, 5 #B busbar, 6 #A busbar, and 6 #B busbar, respectively. A corresponding relationship between the section A and the section B of the busbars serving as mutual backup for different main transformers may be set according to the actual needs, which is not to be described in the present disclosure.

It is worth mentioning that the transformer in the present disclosure may adopt a sectionalized double-bus configuration, and number of sections generally matches number of the main transformers, which can reduce the number of line circuits and of the main transformers that are shut down due to busbar faults.

By adopting the above embodiment, the present disclosure can at least produce the following technical effects. First, compared to the 110 kV substation, adopting the 220 kV substation not only improves power supply capacity of a single substation, but also saves grid-side and municipal resources. Second, the voltage level of the power distribution device in the data center is typically 10 kV. The 220 kV substation provided in the present disclosure may transform the total electrical energy from 220 kV to 10 kV to connect the power distribution device, which leaves out the voltage level of 110 kV and thus reduces the construction costs of the substation. Third, high-voltage users generally have lower wheeling charges than medium-voltage users, and adopting 220 kV power supply can significantly save electricity fees throughout the entire life cycle compared to medium voltage power supply. Fourth, by adjusting the form of the main transformer and optimizing the form of the main wiring without changing a 10 kV side standard device, a 10 kV bus tie cabinet may be canceled, which can fully utilize total capacity of the main transformer and ensure reliable power supply to the data center.

The foregoing descriptions are merely preferred embodiments of the present disclosure, and are not intended to limit the present disclosure. Any modification, equivalent replacement and improvement made within the spirit and principle of the present disclosure shall fall into the protection scope of the present disclosure.

What is claimed is:

1. A transformer for a data center, wherein the transformer is a split winding transformer or a double winding transformer with a voltage level of 220 kV, the transformer comprising two 10 kV low-voltage windings, each of the two 10 kV low-voltage windings being connected to two sections of 10 kV busbars, a plurality of outgoing lines being connected to each of the two sections of 10 kV busbars, and the plurality of outgoing lines being configured to connect a power distribution device of the data center.

2. The transformer as claimed in claim 1, wherein any two sections of the 10 kV busbars are not coupled to each other.

3. The transformer as claimed in claim 1, wherein the split winding transformer is used when capacity of the transformer is greater than 120 MVA; and the double winding transformer is used when the capacity of the transformer is less than or equal to 120 MVA.

4. The transformer as claimed in claim 1, wherein a plurality of transformers are connected in parallel by means of double-bus configuration to serve as main transformers for substations used in the data center.

5. The transformer as claimed in claim 4, wherein 220 kV windings of each of the main transformers use the double-bus configuration, 10 kV windings of each of the main transformers are connected to two sections of 10 kV busbars, and one or more outgoing lines are connected to each section of the 10 kV busbars.

6. The transformer as claimed in claim 5, when capacity of the transformer is greater than 120 MVA, the split winding transformer may be used.

7. The transformer as claimed in claim 6, when the capacity of the main transformer is less than or equal to 120 MVA, a conventional double winding transformer may be used.

8. The transformer as claimed in claim 7, wherein each of the main transformers is the split winding transformer, and a half-ride-through impedance of the split winding transformer is 45%.
